(19) United States
(12) Patent Application Publication
(10) Pub. No.: US 2026/0338352 A1
(43) Pub. Date: Oct. 29, 2026

(54) ARTIFICIAL SKYLIGHT

(71) Applicant: SIGNIFY HOLDING B.V., Eindhoven (NL)

(72) Inventors: MARCUS CORNELIS VAN MEEL, HELMOND (NL); PAUL PHILIP THURSFIELD, EINDHOVEN (NL)

(21) Appl. No.: 19/168,347

(22) PCT Filed: Mar. 19, 2024
(86) PCT No.: PCT/EP2024/057257

§ 371 Date: Sep. 24, 2025

(30) Foreign Application Priority Data
Mar. 28, 2023 (EP) 23164799.1

(51) Int. Cl. F21V 9/02; F21S 8/02; F21S 10/00; F21V 8/00; F21Y 103/10; F21Y 105/16; F21Y 115/10

(52) U.S. Cl. CPC F21V 9/02; F21S 8/026; F21S 10/005; G02B 6/0051; G02B 6/0055; F21V 2200/20; F21Y 2103/10; F21Y 2105/16; F21Y 2115/10

(57) ABSTRACT

A skylight comprising a horizontal sky section (21) configured to emit light resembling a sky visible through a window, and at least one vertical sun section (22a) forming part of a vertical rim (22) extending around the periphery of the sky section (21), each sun section (22a) being configured to emit light resembling sunlight reflected from a surface. The sky section (21) includes a mixing chamber (23) having a horizontal diffusing exit window (24) and a plurality of first solid state light sources (27) arranged to illuminate the mixing chamber (23). Each sun section (22a) includes a vertical lightguide (31) with a reflective backing (32) arranged on an outwards facing side and a diffusor (33) arranged on an inwards facing side, and a plurality of second solid state light sources (35) arranged to couple light into the light guide (31).

### FIELD OF THE INVENTION

The present invention relates to an artificial skylight providing an appearance of a sun-illuminated sky-light. The skylight function includes a light emitting panel for emitting light resembling the sky, and a light emitting rim extending perpendicular to the light emitting panel and for emitting light resembling sunlight reflected by a surface. The skylight may be integrated in a luminaire.

### BACKGROUND OF THE INVENTION

In recent years, artificial skylights have been developed that simulate the effect of a blue sky and sun shining in through a ceiling window. Such artificial skylights typically include a horizontal sky section for emitting light resembling the sky visible through a window, and a sun section in the form of a vertical rim around the periphery of the sky section, where one or several of the sides of the rim are configured to emit light resembling sunlight reflected from a surface.

In some existing designs, the sky section is a horizontal side-lit lightguide having a reflective backing on top, a diffusor facing downwards towards the room, and a polycarbonate pane covering the diffusor. Blue and white light resembling the sky is coupled into lightguide and is extracted by the diffusor, to create the impression of a window facing the sky. The sun section is formed by light emitting side panels include direct-lit light mixing chambers having a diffusive light exit window facing inwards towards the center of the skylight. Light resembling reflected sunlight is directed into the mixing chambers, and exits through the light exit windows, to create the impression of sub-lit window edges.

This design requires a certain volume outside the visible part of the skylight. Firstly, the mixing of light from the LEDs emitting light into the mixing chambers (e.g. warm white and cold white) requires a certain distance. Secondly, the LEDs coupling light into the side-lit panel are arranged outside the visible sky window. Also, the light from these LEDs (e.g. white and blue LEDs) requires a certain distance to achieve satisfactory mixing. This means that the skylight has a frame containing these parts of the skylight, typically in the order of 5 cm wide.

In many office buildings, the inner ceiling is a T-profile grid supporting square ceiling panels which in some cases are sound absorbing. An artificial skylight may then be supported by the T-profile grid, and must then have the same size as one of the square openings, typically around 60 cm square. With this approach, the additional space required outside the visible part of the skylight presents a drawback, as it takes up a portion of the square opening, leaving less room for the visible portion. For example, if the surrounding frame is 6 cm wide, the remaining surface area for the visible part of the skylight will only be 60−2×6=48 cm square.

If the skylight is mounted from below, it will have to fit between the T-profiles, which further reduce the available size. As an example, such T-profiles may have a width of around 2,5 cm, such that the remaining opening is around 57,5 cm square. Again assuming a 6 cm frame leaves only 45,5 cm square for the visible part of the sky section.

US20220026052A1 discloses a skylight fixture including a sky-resembling assembly and a plurality of sun-resembling assemblies.

### SUMMARY OF THE INVENTION

Based on the above, it is an object of the present invention to increase the size of the visible area of the sky section for a given size of an opening where the skylight is mounted.

According to a first aspect of the invention, this and other objects are achieved by a skylight comprising a sky section having a generally flat light emitting surface extending in a plane P and configured to emit light resembling a sky visible through a window, and at least one vertical sun section forming part of a rim being substantially perpendicular to plane P and extending around the periphery of the light emitting surface, each sun section being configured to emit light resembling sunlight reflected from a surface. The sky section includes a mixing chamber having a diffusing exit window forming the light emitting surface, and a plurality of first solid state light sources arranged to illuminate the mixing chamber, each sun section includes a lightguide with a reflective backing arranged on an outwards facing side and a diffusor (also referred to as diffusing panel) arranged on an inwards facing side, and a plurality of second solid state light sources arranged to couple light into the light guide.

In the claims, the words “upstream” and “downstream” are used with reference to a propagation direction along the path of light generation in the skylight to light emission from the skylight. So, for example, upstream the light exit window of the sky section means above the exit window when the skylight is mounted horizontally.

With a design according to the first aspect, the width of the frame which reduces the visible area of the sky section corresponds in principle only to the thickness of the side-lit lightguides forming the light emitting sides of the sun section. This thickness can be limited to one or a few cm, resulting in a potentially much large visible portion of the skylight. As an example, for a skylight mounted from below into an opening of 57,5 cm square, where the width of the frame decreases from 6 cm to 2 cm, the increase in visible area will be almost 40%.

The skylight may further comprise one or several non-illuminated shade sections, wherein the sun section(s) and the shade section(s) together form the rim which is perpendicular to the diffusing exit window.

The sky section may comprise a transparent panel arranged downstream (beneath) the diffusing exit window. This further improves the simulation of a window facing the sky.

Each lightguide may be arranged with one edge located upstream the exit window of the sky section. Consequently, no part of the exit window of the sky section is obscured by the sun sections. The second solid state light sources may then be arranged to couple light into this edge. The upstream-facing edge is typically longer than the side edges, leaving room for more light sources (LEDs). Light sources arranged along this edge are also more easily accessible for electrical connection and driving.

A first portion of the diffusor, which portion is located downstream the sky section, may be arranged at a distance from the lightguide, so as to be located inside an outer edge of the exit window of the sky section. With this design, even when the exit window of the sky section is located inside the sun section(s), the edges of the exit window may be concealed by the diffusor.

A second portion of the diffusor, upstream the first portion, may be arranged in contact with the lightguide, and an intermediate portion, bridging the upper and lower portions forms a ledge, immediately downstream the sky section. In this case, the light exit window (and any transparent panel mounted thereon) may abut the ledge. Hence, when the skylight is mounted in a horizontal ceiling, measured in horizontal direction the second, upper, portion of the diffusing panel is closer to the light guide than the first, lower, portion of the diffusing panel, the bridging ledge then forms a horizontal step/portion in the diffusor and connects the first, lower portion and the second, upper portion of the diffusor. This has the advantage that it ensures that there is no (optical) gap between a diffusing panel of the sun section and the exit window at an end portion of the light exit window. Such a gap may act as an optical leak causing an undesired bright spot/line of light which may have a detrimental effect on the realistic experience of the artificial skylight.

The sky section may be contained in a first housing. Each sun section may be contained in a second housing. Such housings may be interconnected by appropriate means, such as screws.

In some embodiments, the first and second solid-state light sources are all mounted in a common plane on one single carrier. This may allow more cost efficient design and manufacture, as, for example, all LEDs may be mounted on one PCB.

The skylight according to the first aspect of the invention and/or a skylight luminaire according to a second aspect of the invention may advantageously be mounted in an opening of an indoor ceiling system including a grid of bars for suspending ceiling panels. Said skylight luminaire comprises a luminaire and a centrally arranged skylight according to the first aspect of the invention. The indoor ceiling comprises elongated bars (T-bars) extending perpendicular to each other forming a grid with square openings. The openings are suitable for receiving various ceiling panels, e.g. acoustic panels, lighting panels, etc. The design ensures that a large portion of the available space is used for the exit window of the sky section.

### BRIEF DESCRIPTION OF THE DRAWINGS

This and other aspects of the present invention will now be described in more detail, with reference to the appended drawings showing embodiments of the present invention.

FIG. 1 shows a perspective view of a luminaire with a central artificial skylight according to an embodiment of the present invention.

FIG. 2 shows a schematic view of the luminaire in FIG. 1 mounted in a suspended inner ceiling.

FIGS. 3a-b show a schematic side view of how the luminaire is mounted to the suspended ceiling from below.

FIG. 4 is a schematic top view of the luminaire mounted in the ceiling.

FIG. 5 shows a cross section of a part of the artificial skylight of the luminaire in FIG. 1, according to a first embodiment.

FIGS. 6a-d show cross sections of a part of the artificial skylight of the luminaire in FIG. 1, according to further embodiments.

### DETAILED DESCRIPTION

An embodiment of a skylight will herein be described with reference to a skylight surrounded by a flat plate or luminaire. However, the skylight 20 may also be adapted to be mounted to a ceiling as a stand-alone unit.

The terms “horizontal”, “vertical”, “upper”, “lower”, et. Are here used to indicate orientation when the skylight is mounted in a horizontal ceiling. It is noted that the skylight may be mounted with a different orientation, and this choice of references is not intended to have any limiting effect on the disclosure.

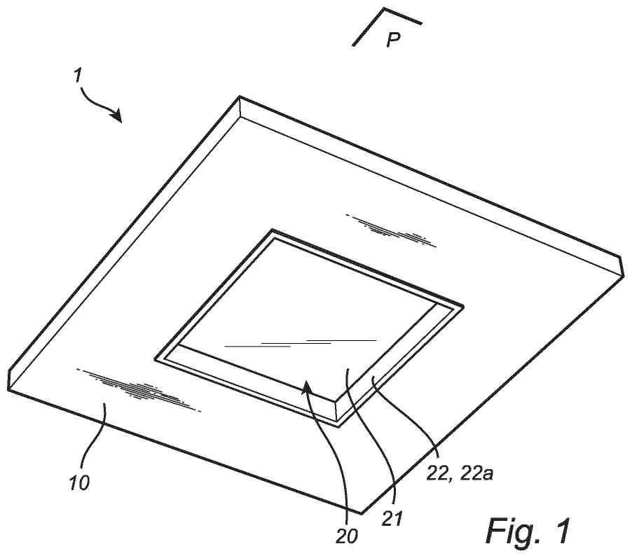

The skylight luminaire 1 in FIG. 1 comprises an artificial skylight 20 centrally arranged in a plate or luminaire 10 surrounding the skylight 20. The surrounding plate/luminaire 10 is here substantially flat and rectangular or square and extend parallel or in a plane P. The skylight 20 is arranged in a rectangular or square opening centrally located in the surrounding plate/luminaire 10. The opening may alternatively be arranged off-center or at an edge of the luminaire 10.

The skylight 20 comprises a horizontal sky section 21 extending in plane P and one or more vertical sun sections 22a extending perpendicular to plane P and arranged around the horizontal sky section. The horizontal sky section 21 is configured to emit a blue light (similar to that of a blue sky) and each vertical sun section 22a is configured to emit a white (or colored) light making it appear like sun light is reflected by the vertical sun section 22a. The sun sections 22a, possibly in combination with one or several non-illuminated vertical sides, form a square rim 22 around the sky section 21. The non-illuminated sides represent shaded sides of the skylight.

In combination, the artificial skylight 20 provides the impression of a window facing a blue and sunny sky. The luminaire 10 is here provided with one or more lighting elements (not shown), typically for providing white office-type illumination. For example, the luminaire 10 can be provided with solid state lighting elements covered by a diffuser which spreads the light more evenly over the lower surface of the luminaire 10. In this way, the luminaire 10 cooperates with the recessed skylight 20 to provide indoor light that appears natural, as if it originates from a sunny outside environment shining through a skylight.

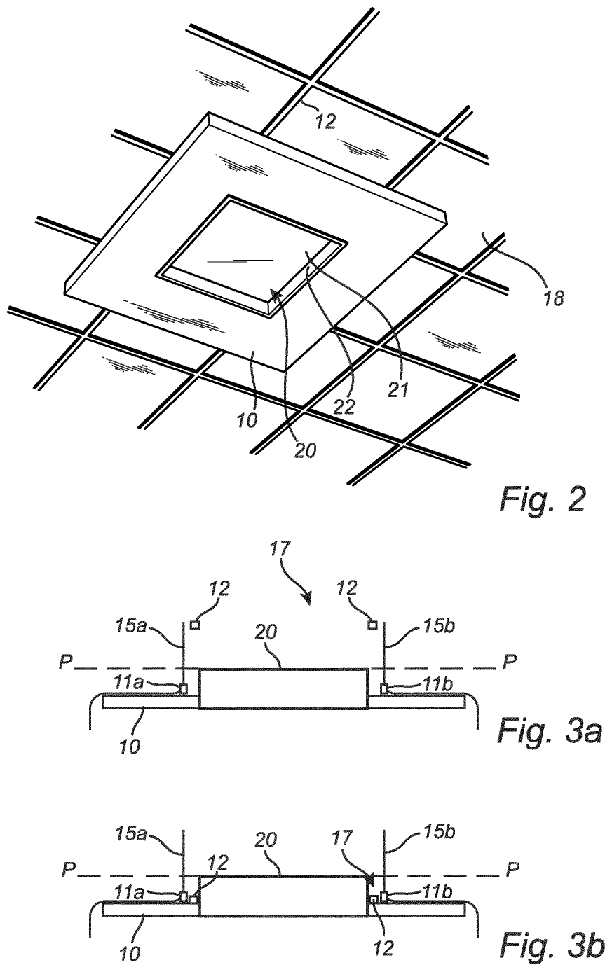

As shown in FIG. 2, the skylight luminaire 1 may be installed in an inner ceiling comprising elongated bars (T-bars) 12 extending perpendicular to each other forming a grid with square openings 17. The openings are suitable for receiving various ceiling panels, e.g. acoustic panels, lighting panels, etc. The skylight luminaire 1 is here mounted in the ceiling grid with the skylight 20 fitted in one of the square grid openings. The plate shaped luminaire 10 is arranged immediately beneath the inner ceiling.

Typically, the bars 12 have a width of 15 mm or 24 mm and are arranged at a center-to-center distance of between 600 mm and 650 mm. For bars 12 with a width of 15 mm arranged at 600 mm distance this gives 585 mm square openings and for bars 12 with a width of 15 mm arranged at 650 mm this gives 635 mm square openings. Similarly, for bars 12 with a width of 24 mm arranged at 600 mm distance this gives 576 mm square openings and for bars 12 with a width of 24 mm arranged at 650 mm this gives 626 mm square openings. Other widths are of course also possible.

Accordingly, the skylight 20 typically has a base that is square with a side between 574 mm and 635 mm depending on the width and separation distance of the grid bars. It is preferable that the recessed skylight 20 is as large as possible while still being able to fit inside a single square opening 17 to provide the most impressive artificial skylight effect while still enabling the skylight 20 to be fitted in an inner ceiling grid. This is true for the skylight luminaire 1 shown in the figures, and also for a stand-alone skylight without surrounding luminaire.

FIGS. 3a-b schematically show how the skylight luminaire extends in plane P and is mounted to the ceiling grid using wires 15a, 15b attached above the inner ceiling (not shown) and in suspension grippers 11a, 11b mounted on the upper surface of the luminaire 10. In FIG. 3a, the luminaire 1 is suspended below the ceiling grid from the wires 15a, 15b. In FIG. 3b, the skylight luminaire 1 has been lifted into the ceiling grid such that the skylight 20 is located in one of the square openings 17 formed by the T-bars 12, while the luminaire 10 is flush with the inner ceiling.

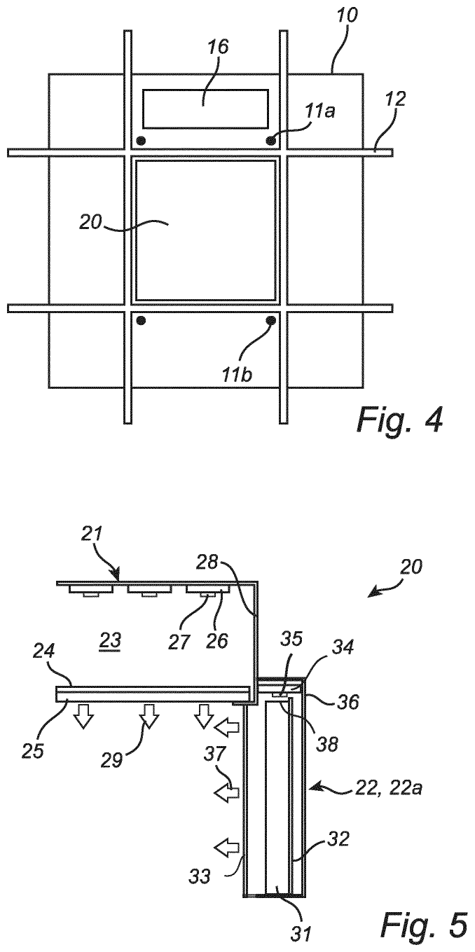

FIG. 4 shows the skylight luminaire 1 from above. The skylight 20 is located in one of the openings 17. Any ceiling panels typically arranged in the surrounding openings have been removed, so that the surrounding luminaire 10 is visible through the grid. In this embodiment, he skylight luminaire 1 further comprises a luminaire driver 16 which is arranged on the upper surface of the surrounding luminaire 10. The skylight driver 16 is configured to provide power to and/or control at least the light elements of the skylight 20, and of any lighting elements in the surrounding luminaire 10. Preferably, the luminaire driver 16 is arranged wholly within the width of the skylight 20 on the same side as one pair of suspension grippers 11a. The luminaire driver 16 can then be contained completely within one single adjacent opening in the ceiling grid, thereby reducing the number of acoustic plates that need to be removed and/or cut.

The skylight 20 will now be described in more detail with reference to FIG. 5. As mentioned above, the skylight 20 includes a sky section 21 intended to be oriented horizontally, and a rim 22 including a set of sun sections 22a and possibly a set of non-illuminated sides. In FIG. 5, only one sun section 22a, forming one side of this rim 22, is shown.

The sky section 21 comprises a mixing chamber 23 having a diffusing light exit window 24, in turn covered by a transparent panel 25. The diffusing exit window may be a polymer plastic sheet, e.g. 1 mm thick. The transparent panel 25 may be a polycarbonate pane, e.g. 1-2 mm thick. The combination of the diffusing panel 24 and the transparent panel 25 may be referred to as a light exit window. The mixing chamber 23 is configured to mix light emitted by a set of LED modules 26, mounted in the upper part of the mixing chamber 23. The LED modules 26 may include various LEDs 27, such as LEDs emitting white and blue light. The mixing chamber 23 is oriented so that the light exit window 24, 25 is facing downwards. In the illustrated example, the sky section is contained in a protective housing 28, e.g. formed by sheet metal or rigid plastic. In one embodiment, the sky section 21 is formed by a housing 28 in the shape of an open box, and the LED modules 26 are mounted inside the housing. The diffusor 24 and polycarbonate panel 25 are mounted as a cover to close the housing 28, thereby forming the light mixing chamber 23.

The sun section 22a comprises a lightguide panel 31, provided with an outwardly facing reflective backing 32 and an inwardly facing diffusor 33 and an edge 38 as incoupling face for light of the solid state light sources 35. Said edge 38 may be flush with or located (slightly) upstream the exit window 24, 25. Light from a set of LED modules 34 including LEDs 35, such as warm white LEDs and cold white LEDs (only one LED 35 is shown in FIG. 5 due to the cross-section view), is coupled into the lightguide. The surface of the lightguide 32 facing the diffusing panel 33 can be provided with suitable outcoupling structures, such as dents, to promote outcoupling of light. The diffusor 33 can be made of suitable polymer plastic sheet, e.g. around 1 mm thick. In the illustrated example, the sun section 22a is contained in a protective housing 36, e.g. formed by sheet metal or rigid plastic.

The housing 28 of the sky section 21 is preferably secured to the housing 36 of the sun section, e.g. by means of screws or the like.

It is noted that the surface area of the sky section 21 visible from below will be the entire base of the skylight 20 except for the area occupied by the combined cross-section of the sun sections 22a. As the lightguides 31 can be made relatively thin, this small area can be kept small. Given a fixed size of an opening 17 in the grid ceiling, the active part of the skylight can be relatively large.

In use, the LEDs 27 will emit light (e.g. blue and white light) into the mixing chamber. The LEDs 27 are selected such that the mixed light will resemble the sky as seen through a window. The mixed light is transmitted through the light exit window formed by the diffusor 24 and polycarbonate panel 25 and exits the sky section 21 as sky light 29.

Further, the LEDs 35 will emit light which is coupled into the lightguide 31. The light from the different LEDs 35 (e.g., warm and cold white light) will be mixed in the lightguide 31, possibly after one or several reflections in the reflecting back side 32. The LEDs 35 are selected such that the mixed light will resemble sunlight reflected from a (e.g. white) surface. The mixed light is emitted through the diffusing panel 33 as reflected sun light 37.

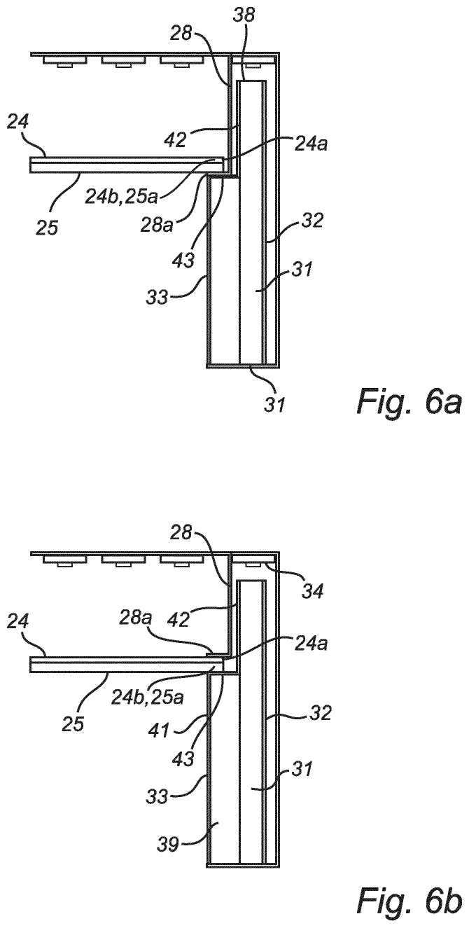

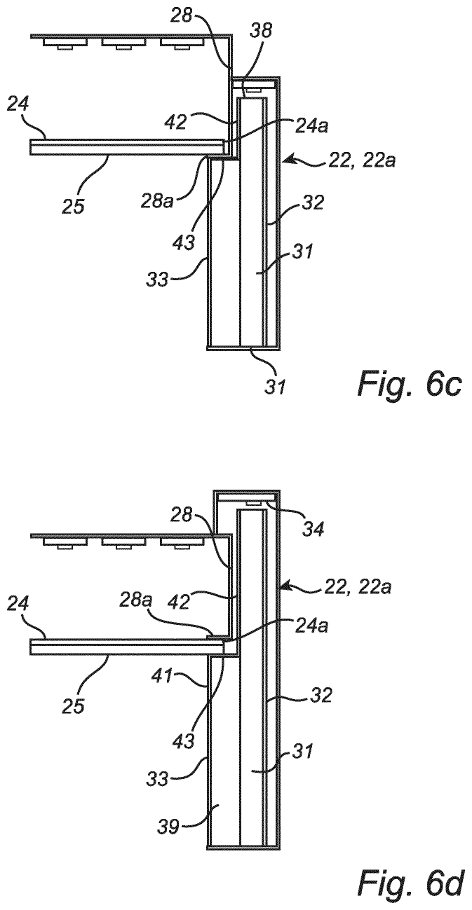

Turning to FIGS. 6a and 6b, a first, lower portion 41 of the diffusing panel 33 which is below the sky section 21 is located at a distance from the lightguide 31, so as to “hide” the edge of the light exit window 24, 25 of the sky section 21. This makes the edge of the sky section invisible from below.

A second, upper portion 42 of the diffusing panel 33 which is above the lower light exit window of the sky section 21 is arranged in contact with the lightguide 31. Portions 41 and 42 are connected by an intermediate portion 43 forming a ledge, here horizontally arranged. Hence, when the skylight is mounted in a horizontal ceiling, measured in horizontal direction the second, upper portion 42 of the diffusing panel 33 is closer to the light guide 31 than the first, lower portion 41 of the diffusing panel 33.

In FIG. 6a, the diffusor 24 and polycarbonate panel 25 are supported by the housing 28 of the sky section 21, and the sky section 21 is arranged so that the bottom housing rim 28a of the housing 28 is located immediately above the ledge 43.

Typically, the skylight is configured, for example in that the diffusing panel 33 has sufficient mechanical strength as such or in that a supporting frame is provided at the diffusing panel, to allow the exit window 24, 25 of the sky section 21 to rest directly with an end portion 24b, 25a adjacent an outer edge 24a of the exit window 24, 25 on the ledge 43, as shown in FIGS. 6a and 6b. This has the advantage that it ensures that there is no (optical) gap between the diffusing panel 33 and the light exit window 24, 25 at its end portion 24b, 25a. The other parts of the sky section 21, contained in housing 28, are then mounted on above the exit window 24, 25, so that the lower housing rim 28a of the housing 28 is located immediately above the diffusor 24.

Although the sections 21, 22a have been discussed as two separate entities (in separate housings 28, 36) the sections 21, 22a may also be embodied as a more integrated unit. Indeed, if the LED modules 26 and 34 are arranged in the same plane, as illustrated in FIGS. 5-6, they may be mounted on a common carrier, such as a common PCB. Note that in the absence of housing 28, some other separation would be required to separate the sun section 22a from the mixing chamber 23. For example, a vertical separation wall could extend down from the common carrier.

In FIG. 6c, the sun section 22a does not extend all the way up to the upper level of the sky section 21. This may be advantageous, as it leaves room for easy attachment of the housing 28 and housing 36.

In FIG. 6d, the sun section 22a instead extends above the upper level of the sky section 21. This may be useful in a situation where the LED module 34 is wider than the light guide 31. With a design as in FIG. 6b or 6c, this relatively wide LED module 34 would then define the width of the frame surrounding the exit window 24. By arranging the LED module 34 above the sky section 21, it may instead extend over the sky section 21, keeping the frame narrow.

The person skilled in the art realizes that the present invention by no means is limited to the preferred embodiments described above. On the contrary, many modifications and variations are possible within the scope of the appended claims. For example, different dimensions and shapes may be implemented in the sky section and sun section. Further, While the skylight is described as being mounted from underneath the grid, it is also possible to mount the skylight from above. Also, the skylight may be mounted in other types of structures than the inner ceiling grid discussed herein.

1. A skylight comprising a sky section having a generally flat light emitting surface configured to emit light resembling a sky visible through a window, and at least one sun section forming part of a rim being substantially perpendicular to and extending around the periphery of the light emitting surface, each sun section configured to emit light resembling sunlight reflected from a surface of said rim, the skylight being characterized in that:
said sky section includes a mixing chamber having a diffusing exit window forming said light emitting surface, and a plurality of first solid state light sources arranged to illuminate the mixing chamber,
each sun section includes a lightguide with a reflective backing arranged on an outwards facing side and a diffusor arranged on an inwards facing side, and a plurality of second solid state light sources arranged to couple light into the light guide,
wherein each lightguide is arranged with one edge located upstream the exit window of the sky section, and
wherein a first portion of the diffusor, which first portion is located downstream the exit window of the sky section, is arranged at a distance from the lightguide so as to be located inside an outer edge of the exit window of the sky section.

2. The skylight according to claim 1, wherein the sky section further comprises a transparent panel arranged downstream the diffusing exit window.

3. The skylight according to claim 1, wherein the second solid state light sources are arranged to couple light into said edge.

4. The skylight according to claim 1, wherein an second portion of the diffusor, which second portion is located upstream the first portion, is arranged in contact with the lightguide, and an intermediate portion, bridging the first portion and the second portion forms a ledge, immediately downstream the sky section.

5. The skylight according to claim 4, wherein the light exit window, and any transparent panel mounted thereon, abuts said ledge.

6. The skylight according to claim 1, wherein the sky section is contained in a first housing.

7. The skylight according to claim 1, wherein each sun section is contained in a second housing.

8. The skylight according to claim 1, wherein each second housing is secured to the first housing.

9. The skylight according to claim 1, wherein the first and second solid-state light sources are mounted in a common plane on one single carrier.

10. The skylight according to claim 1, further comprising one or several non-illuminated shade sections, wherein said sun section(s) and said shade section(s) together form said rim.

11. A skylight luminaire comprising a luminaire and a centrally arranged skylight, according to claim 1.

12. A ceiling system including a grid of bars for suspending ceiling panels and comprising a skylight according to claim 1 and/or a skylight luminaire mounted in one or more openings of a ceiling system.
